(19) United States
(12) Patent Application Publication
(10) Pub. No.: US 2005/0087142 A1
(43) Pub. Date: Apr. 28, 2005

(54) Bolstered pet bed

(76) Inventors: Nayan Dalal, South Plainfield, NJ (US); Sudarshan Uppuluri, South Painfield, NJ (US)

Correspondence Address: EZRA SUTTON, PA;PLAZA 9, 900 ROUTE 9, WOODBRIDGE, NJ, 07095, US

(21) Appl. No.: 10/690,769

(22) Filed: Oct. 22, 2003

(51) Int. Cl. A01K 1/035

(52) U.S. Cl. 119/28.5

(57) ABSTRACT

A bolstered pet bed includes a bottom cushion outer covering having a bottom cushion interior compartment, and a bottom cushion for being received therein; as well as a bolster cushion outer covering having a bolster cushion interior compartment, and a bolster side cushion for being received therein. The bolstered pet bed also includes a zipper for removably connecting the bottom cushion outer covering to the bolster cushion outer covering for forming the bolstered pet bed. Additionally, the bolstered pet bed includes a zipper for opening and closing the bottom cushion interior compartment for removably inserting the bottom cushion therein; and another zipper for opening and closing the bolster cushion interior compartment for removably inserting the bolster side cushion therein.

### FIELD OF THE INVENTION

The present invention relates to a bolstered pet bed for the comfort of animal pets. More particularly, it relates to a bolstered pet bed having a pair of cushion outer coverings detachably connected to each other by a connecting zipper member, and the two outer cushion coverings for detachably and separately receiving therein a bottom cushion and a bolster side cushion, respectively.

### BACKGROUND OF THE INVENTION

Pet beds were originally devised for both the comfort of pets (i.e., dogs, cats, etc.) and to keep the pets from sitting, sleeping, laying on household and bedroom furniture, such as sofas, living room chairs, couches and beds. Although simple throw cushions are often used as a pet bed, many pets would prefer a favorite household couch or owner's bed rather than sleep or lay on a mere cushion, as the pet needs to feel secure and is reluctant to leave the owner's sofa, chair or bed.

Most pet beds are used on a floor area in a pre-determined location within the owner's home or dwelling, such that the pet is expected to make this locations and its pet bed the resting and sleeping place for his or her territorial area in order to feel secure for that location.

Typically, these prior art pet beds include a horizontal bed surface made of a soft, flexible material which is partially surrounded or fully surrounded by a vertical annular wall attached to the horizontal bed surface. The vertical annular wall portion extends upwardly from the perimeter of the horizontal bed surface to the pet bed, leaving an opening through which the pet can enter or leave, and also allowing the pet to see out even while in a supine and lying position. The vertical wall portion is also used as a headrest by the pet who feels safer and has a better view of the surroundings.

There remains a need for a bolstered pet bed having a two piece removable and integrated bed cushion member with a bottom cushion outer covering removably attached to a bolster cushion outer covering, such that the bottom cushion and bolster side cushion are separately received within respective interior compartments of the bottom cushion outer covering and bolster cushion outer covering, respectively. Additionally, the bottom cushion outer covering and the bolster cushion outer covering should include a removably attachable zipper member on the bolster cushion outer covering and the bolster cushion outer covering for separating each of the cushion coverings from each other.

### DESCRIPTION OF THE PRIOR ART

Pet beds, pet pillows, pet rolls, pet cushions, pet lounges and the like having various designs, structures, configurations and materials of construction have been disclosed in the prior art. For example, U.S. Pat. No. 4,860,689 to STEWART discloses a pet lounge having a base member, a body support platform for resting on the base member and for providing a body support for the pet, and a bolster for surrounding at least a portion of the body support platform and for providing a headrest for the pet; the body support platform being vertically adjustable relative to the bolster. This prior art patent does not disclose the design, structure and configuration of the present invention.

U.S. Pat. No. 5,010,843 to HENRY discloses a pet bed including a pair of semi-circular cushions connected along their circumferential perimeters to a circular cushion having substantially the same radius as the semi-circular cushions. The opposed diametral edges of the semi-circular are unattached leaving a trough between them. A pocket is formed between the adjacent surfaces of the semi-circular and circular cushions whereby a pet may crawl into the pocket for resting and sleeping or may lie in the trough surrounded on two sides by the diametral edges of the semi-circular cushions. This prior art patent does not disclose the design, structure and configuration of the present invention.

U.S. Pat. No. 5,197,411 to SCHWARZENBART discloses a pet bed which is flexible and compliant to any surface of furniture or flooring and protects the same from damage by the pet. The pet bed includes a bed body which has a continuous edge, and a roll with a relatively uniform cross section, which extends around a major portion of the edge to enclose a major portion of the bed body. Both the bed body and roll include a padding material which has a drape similar to that of a sleeping bag or bed comforter. This prior art patent does not disclose the design, structure and configuration of the present invention.

U.S. Pat. No. 5,765,502 to HAUGHN discloses a pet bed including an outer covering, a removable cushion disposed within the outer covering to form a cushioned bottom portion, and a bolster removably affixed to the interior of the outer covering and disposed about at least a portion of the perimeter of the bottom portion. The outer covering further includes a reclosable access opening permitting both the bottom cushion and bolster to be removed as needed. The prior art patent does not disclose the design, structure and configuration of the present invention.

None of these prior art patents teach or disclose the structure of a bolstered pet bed having removable and separate cushions for inserting into a bottom cushion outer covering and a bolster cushion outer covering, respectively, and where the bottom cushion outer covering is removably attached to the bolster cushion outer covering as shown in the present invention.

Accordingly, it is an object of the present invention to provide a bolstered pet bed having a bottom cushion outer covering connected to a bolstered side cushion outer covering by a zipper member such that the two outer coverings are removably attached to each other.

Another object of the present invention is to provide a bolstered pet bed that has the bottom cushion being separately received within a bottom cushion interior compartment of the bottom cushion outer covering and the bolster side cushion being separately received within a bolster cushion interior compartment of the bolster cushion outer covering for providing a bed surface for the pet, as well as a headrest surface for the pet.

Another object of the present invention is to provide a bolstered pet bed that is easily maintained, easy to clean, and promotes good pet hygiene.

Another object of the present invention is to provide a bolstered pet bed that uses a pair of outer coverings which are readily washable.

Another object of the present invention is to provide a bolstered pet bed that can be mass produced in an automated and economical manner and is readily affordable by the pet owner.

### SUMMARY OF THE INVENTION

In accordance with the present invention, there is provided a bolstered pet bed for the comfort of animal pets. The bolstered pet bed includes a bottom cushion outer covering having a bottom cushion interior compartment, and a bottom cushion for being received therein; as well as a bolster cushion outer covering having a bolster cushion interior compartment, and a bolster side cushion for being received therein. The bolstered pet bed also includes a zipper for removably connecting the bottom cushion outer covering to the bolster cushion outer covering for forming the bolstered pet bed. Additionally, the bolstered pet bed includes a zipper for opening and closing the bottom cushion interior compartment for removably inserting the bottom cushion therein; and another zipper for opening and closing the bolster cushion interior compartment for removably inserting the bolster side cushion therein.

### BRIEF DESCRIPTION OF DRAWINGS

Further objects, features and advantages of the present invention will become apparent upon the consideration of the following detailed description of the presently preferred embodiment when taken in conjunction with the accompanying drawings, wherein:

FIG. 1 is a front perspective view of the bolstered pet bed of the preferred embodiment of the present invention showing the bolstered pet bed in its assembled configuration;

FIG. 2 is a bottom perspective view of the bolstered pet bed of the present invention showing a zipper member in a closed position on an outer covering;

FIG. 3 is an exploded perspective view of the bolstered pet bed of the present invention showing each of the removable cushions being inserted within first and second interior compartments of each of the outer cushion coverings;

FIG. 4 is a top perspective view of the bolstered pet bed of the present invention showing a bottom cushion outer covering being detachably connected to a bolster cushion outer covering by a zipper member;

FIG. 5 is an enlarged sectional perspective view of the bolstered pet bed of the present invention showing a pair of zipper strip elements of the zipper member connecting the outer coverings together;

FIG. 6 is an enlarged cross-sectional perspective view of the bolstered pet bed of the present invention taken along lines 6-6 of FIG. 4 in the direction of the arrows showing a filling material within a bolster side cushion and an access opening within the bolster cushion outer covering having a zipper for receiving the bolster side cushion therein;

FIG. 7 is a cross-section view of the bolstered pet bed of the present invention taken along lines 7-7 of FIG. 1 in the direction of the arrows showing a filling material within each of the bottom and side cushions and the zipper member connecting the outer bottom cushion covering to the outer bolster cushion covering.

### DETAILED DESCRIPTION OF THE PREFERRED EMBODIMENT

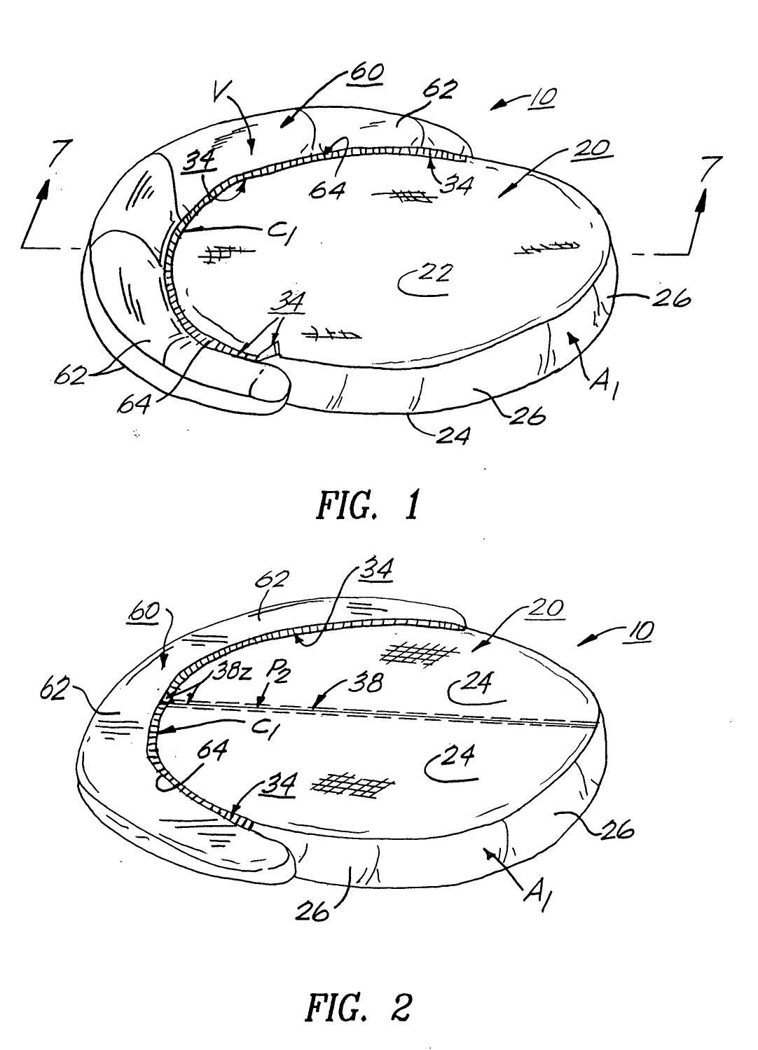

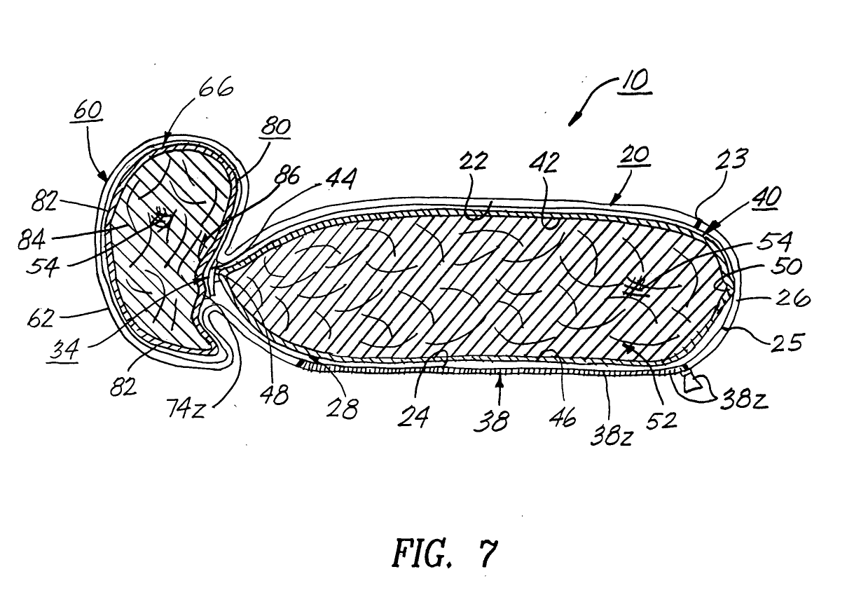

The bolstered pet bed 10 and its component parts of the preferred embodiment of the present invention is represented in detail by FIGS. 1 through 7 of the patent drawings. The bolstered pet bed 10 is used for the comfort of animal pets.

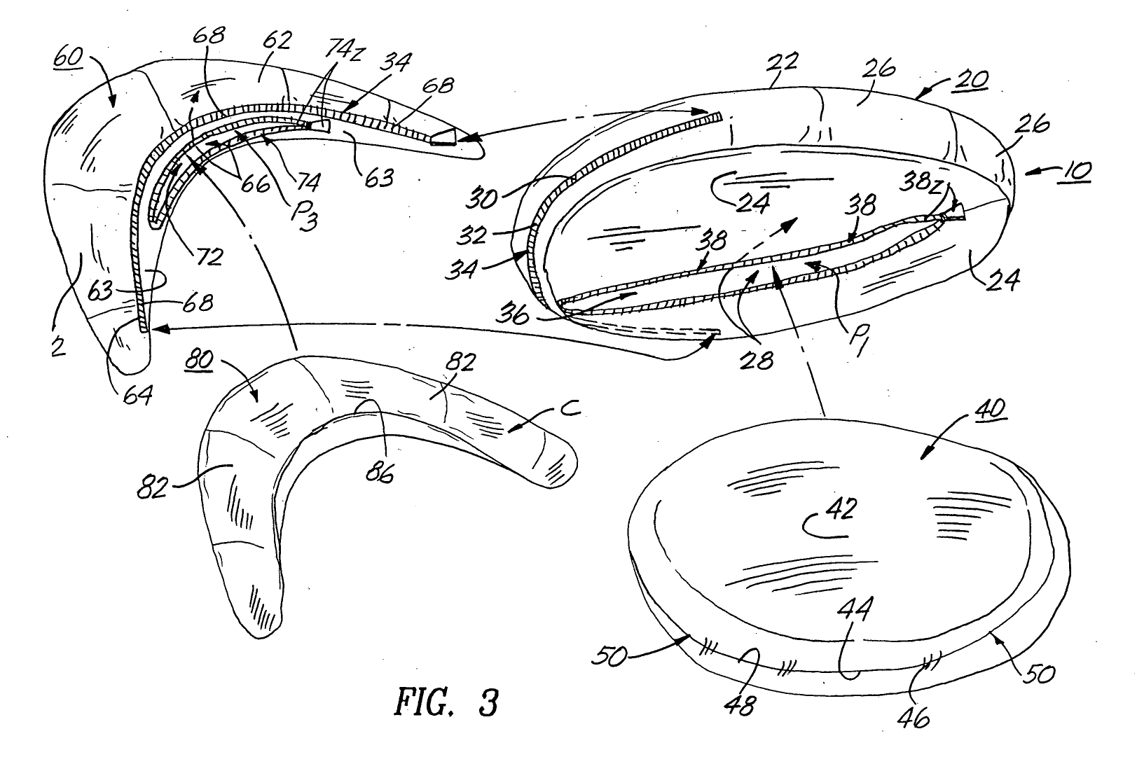

As shown in FIGS. 1 to 5, the bolstered pet bed 10 includes a bottom cushion outer covering 20 and a bolster cushion outer covering 60 for individually receiving therein a bottom cushion 40 and a bolstered side cushion 80, respectively. The bottom cushion outer covering 20 includes a top wall 22, a bottom wall 24 and a circumferential perimeter side wall 26 for forming a bottom cushion interior compartment 28. Top wall 22 includes an upper perimeter edging 23 and bottom wall 24 includes a lower perimeter edging 25 for defining the circumferential perimeter side wall 26. An outer wall seam section 30 of the circumferential perimeter side wall 26 includes a first zipper strip element 32 for use with zipper member 34. The first zipper strip element 32 is fixedly attached to the outer wall seam section 30 of the circumferential perimeter side wall 26, as shown in FIGS. 3, 4, 5 and 7 of the drawings. The bottom wall 24 of the outer bottom cushion covering 20, as shown in FIGS. 2 and 3, includes an access opening 36 for inserting the removable bottom cushion 40 within the bottom cushion interior compartment 30. The access opening 36 includes a first closure means 38 for opening and closing the bottom cushion interior compartment 28 of bottom cushion outer covering 20, as shown in FIGS. 2 and 3 of the drawings. First closure means 38 can be selected from the group consisting of a zipper member 38z, male and female snaps, string ties, button elements, hook and loop fasteners, male and female metal fasteners and the like.

The bolstered pet bed 10, as shown in FIGS. 2, 3 and 7, includes the removable bottom cushion 40. The bottom cushion 40 include a top cushion wall 42 having a circumferential perimeter edging 44 and a bottom cushion wall 46 having a circumferential perimeter edging 48. Each of the circumferential perimeter edges 44 and 48 of the top and bottom cushion walls 42 and 46, respectively, are sewn together at a seam line 50 to form an interior bottom cushion compartment 52 for receiving a polyester fiber fill 54 therein.

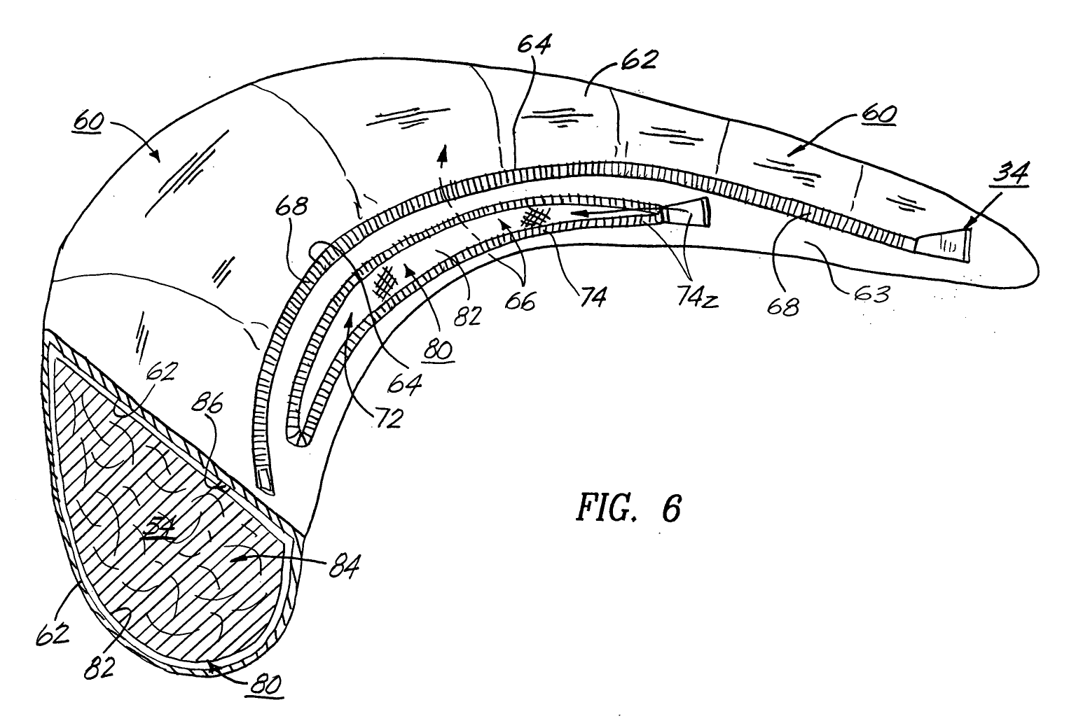

As shown in FIGS. 1, 3, 4 and 6, the bolster cushion outer covering 60 includes a U-shaped front wall 62, a rear wall 63 having a rear perimeter edging 64 for forming a bolstered side cushion interior compartment 66. The rear perimeter edging 64 includes a second zipper strip element 68 for use with zipper member 34. The second zipper strip element 68 is fixed attached to the rear perimeter edging 64 of the outer bolster cushion covering 60, as depicted in FIGS. 5 and 6 of the drawings. An inner wall seam section 70 of the rear perimeter edging 64, as shown in FIGS. 3 and 6, includes a bolster access opening 72 for inserting the removable bolster side cushion 80 within the bolster side cushion interior compartment 66 therein. The bolster access opening 72 includes a second closure means 74 for opening and closing the bolstered side cushion interior compartment 66 of outer bolstered cushion covering 60. Second closure means 74 is adjacent to and in close proximity to the second zipper strip element 68, as showing in FIGS. 5 and 6 of the drawings. The second closure means 72 can be selected from the group consisting of a zipper member 74z, male and female snaps, string ties, bottom elements, hook and loop fasteners, male and female metal fasteners and the like.

The bolstered pet bed 10, as shown in FIGS. 3, 5 and 6 of the drawing, also includes the removable bolster side cushion 80. The bolster side cushion 80 includes an outer front wall 82 formed in a substantially crescent-shape C having an interior bolstered side cushion compartment 84 for receiving the polyester fiber fill 54 therein. The outer wall 82 of bolster side cushion 80 also includes a seam line 86, as shown in FIGS. 3 and 6 of the drawings.

The physical dimensions of the bolstered pet bed 10 is as follows: The bottom cushion 40 being circularly-shaped has a diameter of 32 inches and a depth of 10 inches at the center of the bottom cushion 40. The bolster side cushion 80 being crescent-shaped has a length of 66 inches and a maximum width of 10½ inches. The zipper member 34 has a length of 66 inches. The zipper member 38z of the first closure means 38 on the bottom wall 24 of outer bottom cushion covering has a length of 30 inches. The zipper member 74z of the second closure means 74 on the inner wall seam section 70 of the rear perimeter edging 64 of outer bolster cushion covering 60 has a length of 24 inches. The bolstered pet bed 10 in the assembled stated has a maximum width of 35 inches with the bolstered side cushion 80 having a height of 8 inches and a width of 9½ inches.

### OPERATION OF THE PRESENT INVENTION

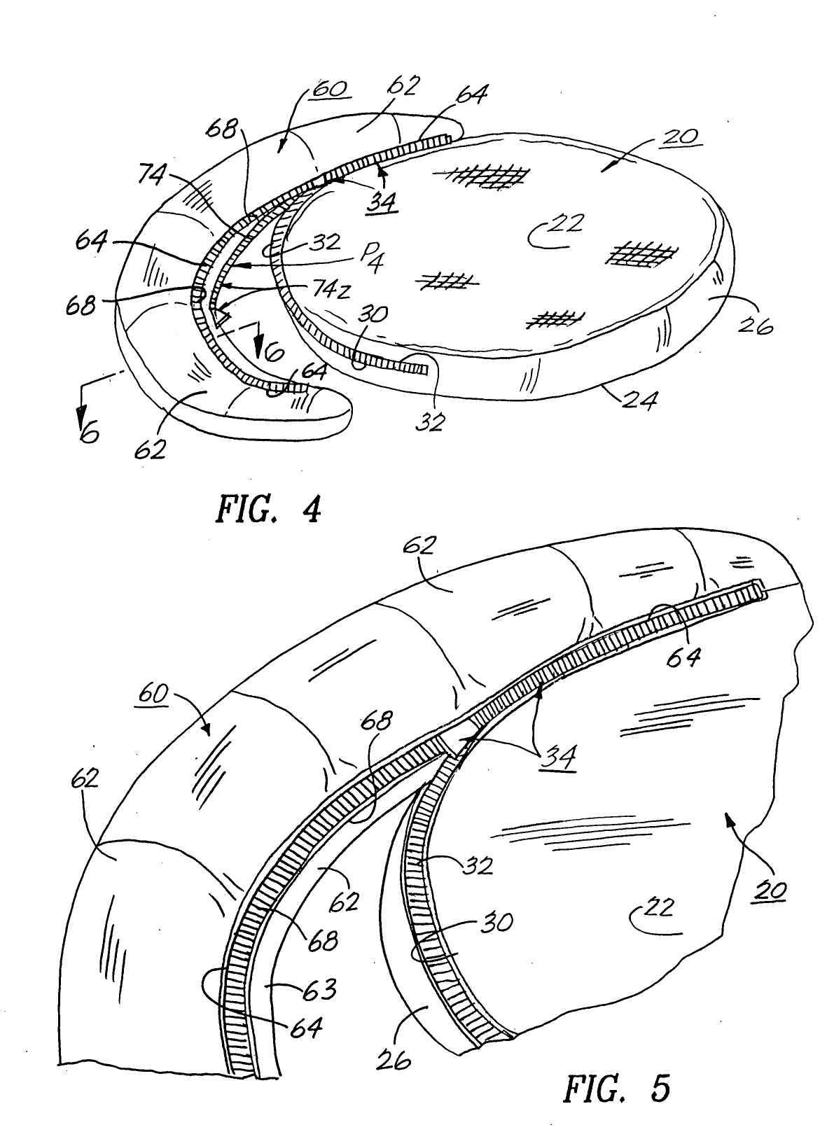

In assembling the bolstered pet bed 10, as shown in FIGS. 3 through 6 of the drawings, the bottom cushion 40 is inserted through the access opening 36 by opening the zipper member 38z on the bottom wall 24 of the bottom cushion outer covering 20 to an opened configuration P₁. The bottom cushion 40 is then positioned within the bottom cushion interior compartment 28 of the bottom cushion outer covering 20, and then the access opening 36 is closed via zipper member 38z on the bottom wall 24 of bottom cushion outer covering 20 to a closed configuration P₂, as depicted in FIG. 2 of the drawings. Next, the bolster side cushion 80 is inserted through the access opening 72 by opening the zipper member 74z on the rear wall 63 of the bolster cushion outer covering 60 to an opened configuration P₃. The bolster side cushion 80 is then positioned within the bolster side cushion interior compartment 66 of the bolster cushion outer covering 60, and then the access opening 72 is closed via zipper member 74z, on the rear wall 63 of bolster cushion outer covering 60 to a closed configuration P₄, as depicted in FIGS. 2 and 4 of the drawings.

The user now places and positions each of the first and second zipper strip elements 32 and 68 of zipper member 34 of the outer coverings 20 and 60, respectively, in alignment with each other such that the user closes the zipper strip elements 32 and 68 of zipper member 34 on the outer coverings 20 and 60 to a closed configuration C₁ to form an assembled bolstered pet bed 10 designated A₁, as shown in FIGS. 1 and 2 of the drawings. The bolstered pet bed 10 is now in condition for use by the pet animal.

### ADVANTAGES OF THE PRESENT INVENTION

Accordingly, an advantage of the present invention is that is provides for a bolstered pet having a bottom cushion outer covering connected to a bolstered side cushion outer covering by a zipper member such that the two outer coverings are removably attached to each other.

Another advantage of the present invention is that it provides for a bolstered pet bed that has the bottom cushion being separately received within a bottom cushion interior compartment of the bottom cushion outer covering and the bolster side cushion being separately received within a bolster cushion interior compartment of the bolster cushion outer covering for providing a bed surface for the pet, as well as a headrest surface for the pet.

Another advantage of the present invention is that it provides for a bolstered pet bed that is easily maintained, easy to clean, and promotes good pet hygiene.

Another advantage of the present invention is that it provides for a bolstered pet bed that uses a pair of outer coverings which are readily washable.

Another advantage of the present invention is that it provides for a bolstered pet bed that can be mass produced in an automated and economical manner and is readily affordable by the pet owner.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1. A bolstered pet bed, comprising:
a) a bottom cushion outer covering having a bottom cushion interior compartment, and a bottom cushion having a circular shape and forming a pet bed for pets; said bottom cushion being received within said bottom cushion interior compartment;
b) a bolster cushion outer covering having a bolster cushion interior compartment, and a bolster side cushion for pets being received therein; said bolster side cushion being semi-circular in shape;
c) zipper connecting means for removably connecting the side of said bottom cushion outer covering the side of said bolster cushion outer covering for forming said bolstered pet bed; said zipper connecting means includes a zipper member connected to both said bottom cushion outer covering and to said bolster cushion outer covering in an affixed and secure manner; said zipper member includes a first zipper strip element being fixedly attached to an outer side wall section of said bottom cushion outer covering and a second zipper strip element being fixedly attached to an inner side wall section of said bolster cushion outer covering;
d) first closure means for opening and closing said bottom cushion interior compartment for removably inserting said bottom cushion therein;
e) second closure means for opening and closing said bolster cushion interior compartment for removably inserting said bolster side cushion therein; and
f) said zipper member being affixed to a side of said bottom cushion outer covering having said bottom cushion therein, and to a side of said bolster cushion outer covering having said bolster side cushion therein, such that said zipper member securely holds in place said bolster side cushion ill a secure and upstanding manner relative to said bottom cushion and thereby forms an upstanding and raised headrest surface with respect to said bottom cushion for resting of a pet's head on said raised headrest surface.

2. A bolstered pet bed in accordance with claim 1, wherein said connecting means includes a zipper member for removably connecting said bottom cushion outer covering to said bolster outer cushion covering.

3. A bolstered pet bed in accordance with claim 1, wherein said zipper member includes a first zipper strip element being fixedly attached to an outer side wall section of said bottom cushion outer covering and a second zipper strip element being fixedly attached to an inner side wall section of said bolster cushion outer covering.

4. A bolstered pet bed in accordance with claim 1, wherein said first closure means for opening and closing said bottom cushion interior compartment are selected from the group consisting of a zipper member, male and female snaps, string ties, button elements, hook and loop fasteners, and male and female metal fasteners.

5. A bolstered pet bed in accordance with claim 1, wherein sad second closure means for opening and closing said bolster cushion interior compartment are selected from the group consisting of a zipper member, male and female snaps, string ties, button elements, hook and loop fasteners, and male and female metal fasteners.

6. A bolstered pet bed in accordance with Claim 1, wherein said bolster side cushion is semi-circular in shape and has an arc length of 66 inches and a maximum width of 10.5 inches.

7. A bolstered pet bed in accordance with claim 1, wherein said bottom cushion has a diameter of 32 inches and a depth of 10 inches at the center of said bottom cushion.

8. A bolstered pet bed in accordance with claim 1, wherein said second zipper strip element on said inner side wall section of said bolster cushion outer covering is adjacent to said second closure means.

9. A bolstered pet bed in accordance with claim 1, wherein said zipper member has a length of 66 inches.

10. A bolstered pet bed in accordance with claim 1, wherein said bottom cushion and said bolster side cushion each have a filling of polyester fiber.

11. A bolstered pet bed in accordance with claim 4, wherein said zipper member of said first closure means has a length of 30 inches.

12. A bolstered pet bed in accordance with claim 5, wherein said zipper member of said second closure means has a length of 24 inches.
